(19) United States
(12) Patent Application Publication
(10) Pub. No.: US 2006/0225066 A1
(43) Pub. Date: Oct. 5, 2006

(54) Systems and methods for extending an application on a mobile information device with additional functionality

(75) Inventor: Jeffrey S. Vigil, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/098,345

(22) Filed: Apr. 4, 2005

(51) Int. Cl. G06F 9/44

(52) U.S. Cl. 717/168

(57) ABSTRACT

An exemplary method may be performed by a server system that implements the Mobile Information Device Profile. In accordance with the method, one or more files are provided that extend a MIDlet with additional functionality. The files may include Java® class files, content files (e.g., images), etc. A packaging component packages the files to create a MIDlet extension. The packaging component creates a descriptor for the MIDlet extension. The packaging component adds extension properties to the descriptor. The extension properties identify the MIDlet extension as an extension to the MIDlet and facilitate discovery of the MIDlet extension. The descriptor is associated with the MIDlet extension.

### TECHNICAL FIELD

The present invention relates generally to computers and computer-related technology. More specifically, the present invention relates to systems and methods for extending an application on a mobile information device with additional functionality.

### BACKGROUND

Computer technologies continue to advance at a rapid pace. Indeed, computers are used in almost all aspects of business, industry and academic endeavors. Improvements in computer technologies have been a force for bringing about great increases in business and industrial productivity. More and more homes are using computers as well.

There are many different kinds of computers in use today. The term “computer system” will be used herein to refer generally to any device or combination of devices that is capable of processing information to produce a desired result. Some examples of computer systems include personal computers, hand-held computers, personal digital assistants (PDAs), servers, mainframes, supercomputers, minicomputers, workstations, microcomputers, microcontrollers, and the like.

Java® is an object-oriented programming language designed to generate applications that can run on all hardware platforms without modification. Source code that is written in the Java® programming language is compiled into byte code. The byte code is then run on a Java® Virtual Machine (JVM), which is a program written in native code on the host hardware that translates Java® byte code into usable code on the hardware.

The Java® 2 Platform, Micro Edition (J2ME) is a technology that allows programmers to use the Java® programming language to develop applications for embedded devices, such as mobile phones, personal digital assistants (PDAs), pagers, etc. Such devices may be referred to as mobile information devices (MIDs).

The Mobile Information Device Profile (MIDP) defines an architecture and the associated application programming interfaces (APIs) for facilitating an application development environment for MIDs. An application that is written for the MIDP is referred to as a MIDlet. One or more MIDlets may be packaged together in a Java® archive (JAR) file to create a MIDlet suite. As used herein, the term MIDlet may refer to either a standalone MIDlet or to a MIDlet that is part of a MIDlet suite.

In some situations, it may be desirable to provide additional functionality for an existing MIDlet. One way to accomplish this is to create a new version of the MIDlet that includes the additional functionality. In order to obtain the additional functionality, the user downloads the new version of the MIDlet in its entirety. The new MIDlet may include some of the same files as the previous version of the MIDlet. Thus, downloading the new version of the MIDlet may be somewhat inefficient, because some files of the MIDlet may be downloaded multiple times. Accordingly, benefits may be realized by improved systems and methods for providing additional functionality for an existing MIDlet. Some exemplary systems and methods for providing additional functionality for an existing MIDlet are described herein.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 illustrates components in an embodiment of a system for extending a MIDlet with additional functionality, including a server system that implements the MIDP, a MIDlet extension, and an accompanying descriptor;

FIG. 2 illustrates an embodiment of a descriptor for a MIDlet extension;

FIG. 3 illustrates various components in an MID that may be used to discover and download a descriptor and a MIDlet extension from an MIDP server system;

FIG. 4 illustrates various components in an MID that may be used to invoke one or more MIDlets that have been installed on the MID;

FIG. 5 illustrates various components in an MID that may be used to uninstall a MIDlet extension from an MID;

FIG. 6 illustrates an embodiment of a method for extending a MIDlet with additional functionality;

FIG. 7 illustrates another embodiment of a method for extending a MIDlet with additional functionality;

FIG. 8 illustrates another embodiment of a method for extending a MIDlet with additional functionality; and

FIG. 9 illustrates the major hardware components typically utilized in a computer system.

### DETAILED DESCRIPTION

Systems and methods for extending a MIDlet with additional functionality are disclosed. An exemplary method may be performed by a server system that hosts one or more MIDlet suites and one or more MIDlet descriptors for download. One or more files that extend the MIDlet with additional functionality are provided. A packaging component packages the one or more files to create a MIDlet extension. The packaging component also creates a descriptor for the MIDlet extension.

At least one extension property is added to the descriptor. The at least one extension property identifies the MIDlet extension as an extension to the MIDlet and facilitates discovery of the MIDlet extension. One example of an extension property is a name property that identifies a name of the MIDlet that is being extended. Another example of an extension property is a vendor property that identifies a vendor of the MIDlet that is being extended. Another example of an extension property is a version property that identifies a version of the MID let that is being extended. The at least one extension property may include an extension identifier. The descriptor is associated with the MIDlet extension.

The server system may also allow mobile information devices to discover the descriptor. The server system may receive a request from a mobile information device to transmit the descriptor to the mobile information device. In response to this request, the server system may transmit the descriptor to the mobile information device. The server system may receive a request from the mobile information device to transmit the MIDlet extension to the mobile information device. In response to this request, the server system may transmit the MIDlet extension to the mobile information device.

A server system that is configured to implement the exemplary method described above is also disclosed. The server system includes a processor, and memory in electronic communication with the processor. Instructions are stored in the memory. The instructions are executable to implement the exemplary method described above. A computer-readable medium comprising executable instructions for implementing the exemplary method described above is also disclosed.

Another exemplary method for extending a MIDlet with additional functionality may be performed by a mobile information device. The mobile information device may receive a descriptor for a MIDlet extension from a server. The MIDlet extension includes one or more files that extend the MIDlet with additional functionality. Information from the descriptor may be provided to a user. An application manager may receive a download request from the user to download the MIDlet extension. In response to the download request, the application manager sends a request to the server to transmit the MIDlet extension to the mobile information device. The server fulfills the request, and the mobile information device receives the MIDlet extension from the server without receiving an additional copy of the MIDlet. An installer installs the MIDlet extension on the mobile information device. The application manager may update a system-level extensions property that is associated with the MIDlet in response to installing the MIDlet extension.

At some point, the application manager may receive a request from the user to uninstall the MIDlet extension. In response to the uninstallation request, the application manager uninstalls the MIDlet extension from the mobile information device without uninstalling the MIDlet. The system-level extensions property that is associated with the MIDlet may be updated in response to uninstalling the MIDlet extension.

Another embodiment of a method for extending a MIDlet with additional functionality is also disclosed. The method may be performed by a mobile information device. The mobile information device may receive a request from a user to invoke a MIDlet. In response to the request, an application manager on the mobile information device invokes the MIDlet.

The mobile information device determines that a MIDlet extension is installed on the mobile information device. In some embodiments, this involves querying a system-level extensions property that is associated with the MIDlet. The application manager discovers the MIDlet extension. This may involve querying extensions properties within a descriptor that is associated with the MIDlet extension. The application manager invokes the MIDlet extension. The MIDlet and the MIDlet extension may be linked so that the MIDlet can access the MIDlet extension's class and content files, and vice versa.

A mobile information device that is configured to implement one or more of the exemplary methods described above is also disclosed. The mobile information device includes a processor, and memory in electronic communication with the processor. Instructions are stored in the memory. The instructions are executable to implement one or more of the exemplary methods described above. A computer-readable medium comprising executable instructions for implementing one or more of the exemplary methods described above is also disclosed.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

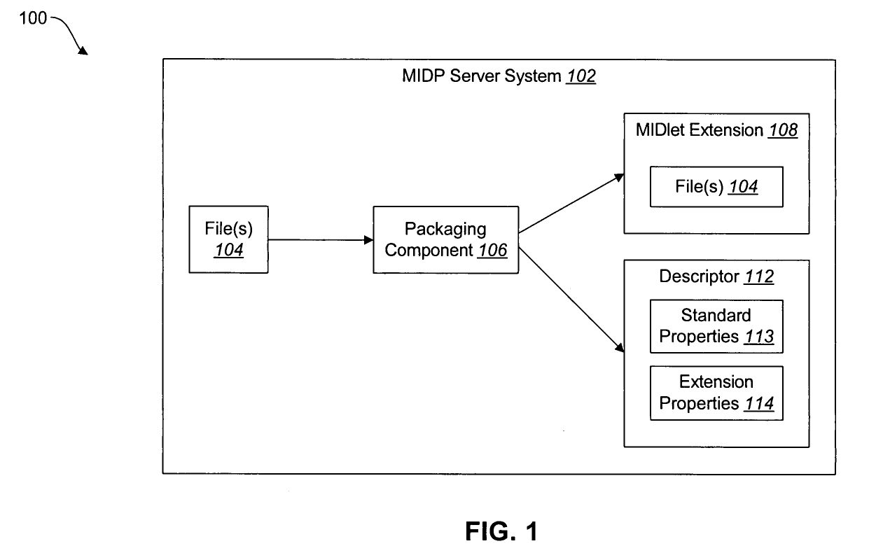

As indicated above, the Mobile Information Device Profile (MIDP) defines an architecture and the associated application programming interfaces (APIs) for facilitating an application development environment for mobile information devices (MIDs), such as mobile phones, personal digital assistants (PDAs), pagers, etc. An application that is written for the MIDP is referred to as a MIDlet. FIG. 1 illustrates components in an embodiment of a system 100 for extending a MIDlet with additional functionality. The system 100 includes a server system 102 that hosts one or more MIDlet suites and MIDlet descriptors for download.

An application developer may create one or more files 104 that extend an existing MIDlet (not shown in FIG. 1) with additional functionality. For example, the files 104 may provide additional levels for an existing game. The files 104 may include Java® class files, content files (e.g., images), etc.

A packaging component 106 packages the files 104 to create a MIDlet extension 108. In some embodiments, the packaging component 106 may be a Java® Archive Tool, and the files 104 may be packaged together in a Java® archive (JAR) file.

In accordance with the MIDP specification, a descriptor is created for each MIDlet (or MIDlet suite) that is made available for download by an MID. A descriptor is a file that is associated with, but separate from, a MIDlet. The descriptor for a MIDlet includes information about the MIDlet, such as the name of the MIDlet, the size of the MIDlet, etc.

In the illustrated embodiment, the packaging component 106 creates a descriptor 112 for the MIDlet extension 108. The descriptor 112 is a file that is associated with, but separate from, the MIDlet extension 108. The descriptor 112 includes information about the MIDlet extension 108. More specifically, the descriptor 112 includes various properties, including one or more standard properties 113 and one or more extension properties 114. The standard properties 113 are properties that are presently defined in the MIDP specification. In contrast, the extension properties 114 are not presently defined in the MIDP specification. The extension properties 114 identify the MIDlet extension 108 as an extension to an existing MIDlet, and facilitate discovery of the MIDlet extension 108.

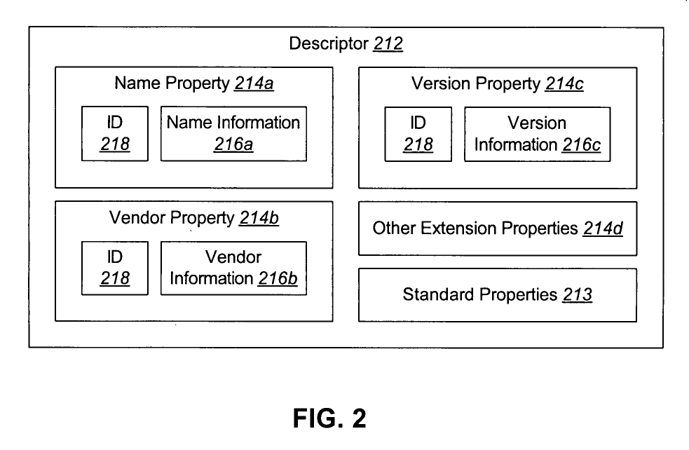

FIG. 2 illustrates an embodiment of a descriptor 212 for a MIDlet extension 108. The descriptor 212 includes various standard properties 213 that are presently defined in the MIDP specification. In addition, the descriptor 212 includes one or more extension properties 214, including a name property 214a, a vendor property 214b, and a version property 214c.

The name property 214a includes name information 216a that identifies the name of the MIDlet that is being extended. In some embodiments, the name information 216a may be formatted as “MIDlet-Extends-Name.”

The vendor property 214b includes vendor information 216b that identifies the vendor of the MIDlet that is being extended. In some embodiments, the vendor information 216b may be formatted as “MIDlet-Extends-Vendor.”

The version property 214c includes version information 216c that identifies the version of the MIDlet that is being extended. In some embodiments, the version information 216c may be formatted as “MIDlet-Extends-Version.”

The descriptor 212 may include other extension properties 214d as well. These other extension properties 214d may be defined by the original MIDlet so that the original MIDlet may identify the extension, and obtain entry points to its class files. This allows for discovery and instantiation of extension objects.

In the illustrated embodiment, each extension property 214 includes an extension identifier 218. The MIDP API provides a function System.getProperty(property name) that makes it possible to extract a property from a MIDlet suite or JAD. The extension identifier 218 makes it possible to extract a property from a MIDlet extension. The extension identifier 218 may be formatted as “\Extension-<n>\” where “<n>” indicates the number of the extension (i.e., “<n>” is one for the first extension and is incremented for each subsequent extension). The extension identifier 218 may be positioned at the beginning of an extension property 214, i.e., each extension property 214 may be prefaced with an extension identifier 218. As an example, the property “\Extension-1\MIDlet-Name” may indicate the name of the first extension to a MIDlet.

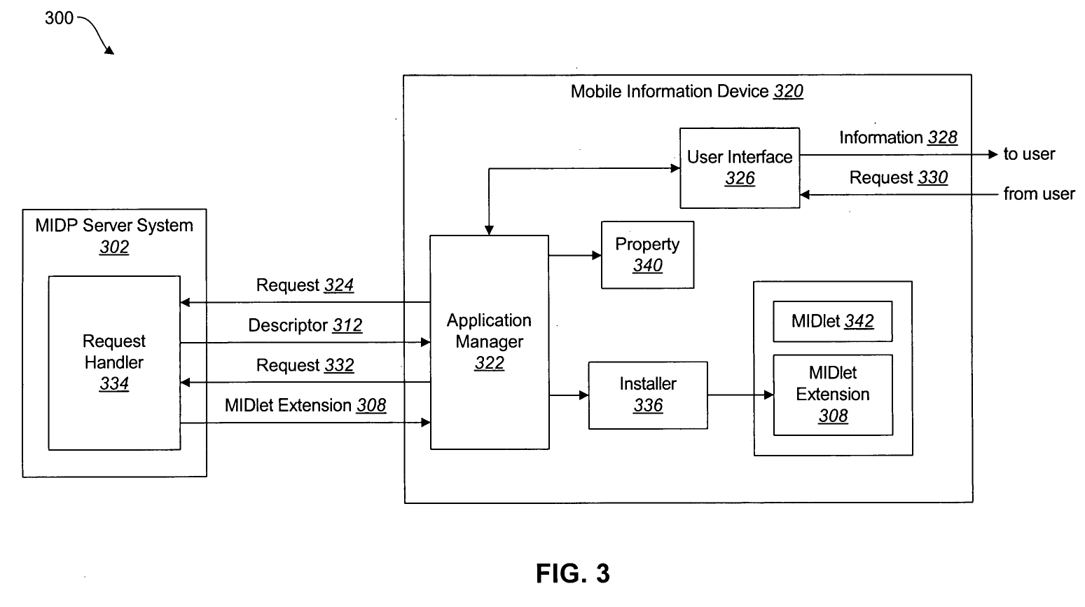

Once a MIDlet extension and an accompanying descriptor have been created, MIDs may be allowed to discover and download the descriptor and the MIDlet extension from an MIDP server system. FIG. 3 illustrates various components that may be used to implement this functionality in some embodiments.

The system 300 shown in FIG. 3 includes a mobile information device (MID) 320 in electronic communication with an MIDP server system 302. The MID 320 includes an application manager 322. In some embodiments, the application manager 322 may be a Java® Application Manager (JAM). In the MDP specification, the application manager 322 is sometimes referred to as Application Management Software (AMS).

The application manager 322 is configured to manage the downloading and lifecycle of MIDlets. In the illustrated embodiment, where an extension 308 to a MIDlet 342 is available for download from an MIDP server system 302, the application manager 322 also manages the downloading and lifecycle of the MIDlet extension 308.

More specifically, at some point the application manager 322 may send a request 324 to the MIDP server system 302 to transmit a descriptor 312 for a MIDlet extension 308 to the MID 320. The request 324 may be included as part of a general request to transmit multiple descriptors to the MID 320. For example, in some embodiments the application manager 322 may periodically request that the MIDP server system 302 transmit any new descriptors that have become available to the MID 320.

In response to the request 324, a request handler 334 on the MIDP server system 302 transmits the descriptor 312 to the MID 320. The application manager 322 provides information 328 from the descriptor 312 to the user of the MID 320 via a user interface 326. This has the effect of notifying the user that the MIDlet extension 308 is available to be downloaded.

For example, suppose that a game (i.e., a MIDlet 342) is installed on the MID 320, and that at least one new level for the game (i.e., a MIDlet extension 308) becomes available. At some point after the new level for the game becomes available to be downloaded, the application manager 322 may download the descriptor for the new level of the game from the MIDP server system 302. The application manager 322 may display information from the descriptor (e.g., a brief description of the new level of the game) to a user of the MID 320. This has the effect of notifying the user that the new level for the game is available to be downloaded.

If the user decides to download the MIDlet extension 308 that corresponds to the descriptor 312, the user submits a request 330, via the user interface 326, to download the MIDlet extension 308. The user's request 330 is received by the application manager 322.

In response to the user's request 330, the application manager 322 sends a request 332 to the MIDP server system 302 to transmit the MIDlet extension 308 to the MID 320. The request handler 334 on the MIDP server system 302 fulfills the request 332 and transmits the MIDlet extension 308 to the MID 320.

In some situations, the system 300 shown in FIG. 3 may provide some advantages relative to known J2ME systems. As indicated above, in known J2ME systems a developer may create a new version of a MIDlet that includes additional functionality relative to a previous version of the MIDlet. However, there is no mechanism for separating the files of the MIDlet that implement the new functionality from the other files of the MIDlet. Thus, to have the new functionality implemented on the MID, the new version of the MIDlet is downloaded in its entirety, possibly including some files that have previously been downloaded to and installed on the MID. This approach may be somewhat inefficient, because some files of the MIDlet may be downloaded and installed multiple times.

In contrast, in the system 300 shown in FIG. 3, the user of the MID 320 is able to download just the MIDlet extension 308, without downloading the original MIDlet 342. In other words, when the MIDlet extension 308 is transmitted to the MID 320, the original MIDlet 342 does not have to be re-transmitted to the MID 320. Where the original MIDlet 342 has already been downloaded to and installed on the MID 320, such an approach may provide for a more efficient use of resources for both the MIDP server system 302 and the MID 320.

When the MID 320 receives the MIDlet extension 308, the application manager 322 invokes an installer 336. The installer 336 installs the MIDlet extension 308 on the MID 320. When the MIDlet extension 308 is installed on the MID 320, the application manager 322 updates an extensions property 340 that is associated with the original MIDlet 342. The extensions property 340 is a system-level property, i.e., the property 340 is maintained by the MID 320. The extensions property 340 indicates how many extensions for the MIDlet 342 have been installed on the MID 320. In some embodiments, if the value of the system-level extensions property 340 is N (where N may be any integer that is greater than or equal to zero), then N extensions to the MIDlet 342 are installed on the MID 320.

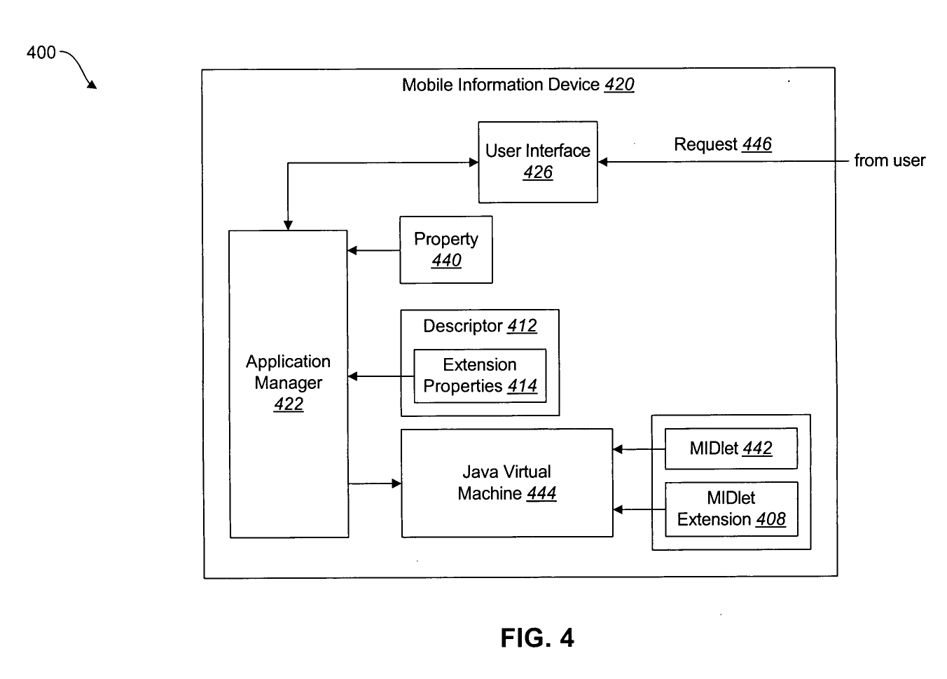

The discussion provided above in connection with FIG. 3 has focused on the ability of an MID to discover, download, and install a MIDlet extension from an MIDP server system. From time to time, a user of an MID may invoke one or more MIDlets that have been installed on the MID. In some embodiments, when a MIDlet is invoked, any extensions to the MIDlet that are installed on the MID may also be automatically invoked. FIG. 4 illustrates various components that may be used to implement this functionality in some embodiments.

The system 400 shown in FIG. 4 includes a MIDlet 442 installed on an MID 420. An extension 408 to the MIDlet 442 is also installed on the MID 420. When a user wants to launch the MIDlet 442, the user submits a request 446 to launch the MIDlet 442 via a user interface 426. In response to the request 446, an application manager 422 invokes the MIDlet 442. More specifically, the application manager 422 starts a Java® virtual machine (JVM) 444 (if the JVM 444 is not already running), and loads the MIDlet 442 into the JVM 444.

The application manager 422 also determines whether there are any extensions to the MIDlet 442 that are installed on the MID 420. In the illustrated embodiment, the application manager 422 makes this determination by querying a system-level extensions property 440 that indicates how many extensions for the MIDlet 442 have been installed on the MID 420.

In the illustrated embodiment, the application manager 422 determines that there is one extension 408 to the MIDlet 442 installed on the MID 420. The application manager 422 then discovers the extension 408. In other words, the application manager 422 identifies the extension 408 from among other MIDlets and/or MIDlet extensions that may be installed on the MID 420. The application manager 422 may discover the extension 408 by querying the extension properties 414 within the descriptor 412 that is associated with the MIDlet 442.

When the extension 408 has been discovered, the application manager 422 invokes the extension 408. More specifically, the application manager 422 loads the extension 408 into the JVM 444. The MIDlet 442 and the MIDlet extension 408 are linked so that the MIDlet 442 can access the MIDlet extension's 408 class and content files, and vice versa.

The above discussion has focused on the operation of various components, including the application manager 422, in response to a user of the MID 420 invoking a MIDlet 442. As discussed above, the application manager 422 may be configured to automatically invoke the extension 408 to the MIDlet 442 in response to the MIDlet 442 being invoked by the user. In some embodiments, the user of the MID 420 may invoke the MIDlet extension 408 instead of the MIDlet 442. When this occurs, the application manager 422 may be configured to automatically invoke the original MIDlet 442 in response to the MIDlet extension 408 being invoked by the user.

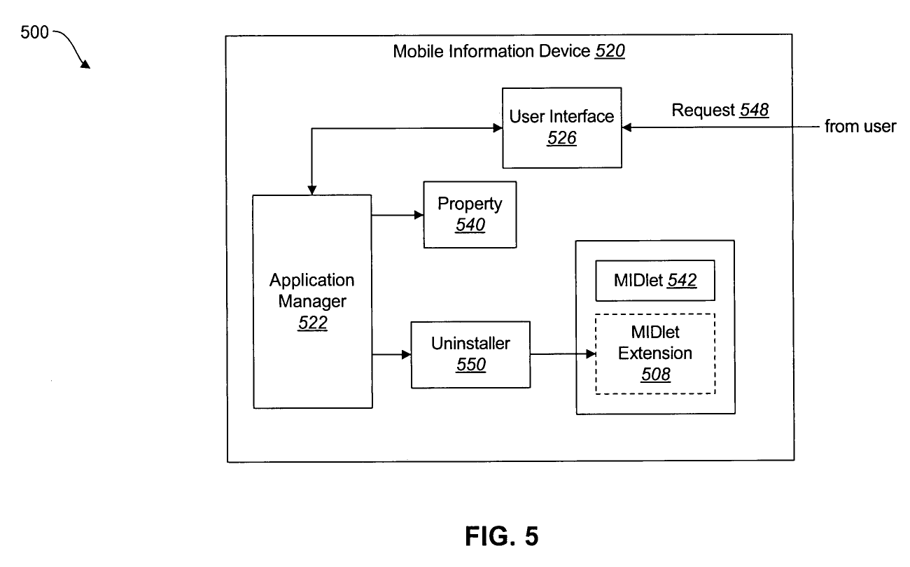

At some point, a user of an MID may decide to uninstall a MIDlet extension from an MID. In some embodiments, a MIDlet extension may be uninstalled from an MID without uninstalling the original MIDlet. FIG. 5 illustrates various components that may be used to implement this functionality.

More specifically, the system 500 shown in FIG. 5 includes a MIDlet 542 and an extension 508 to the MIDlet 542 installed on an MID 520. When a user wants to uninstall the extension 508, the user submits a request 548 to uninstall the extension 508 via the user interface 526. In response to the request 548, the application manager 522 invokes an uninstaller 550. The uninstaller 550 uninstalls the MIDlet extension 508. Advantageously, the extension 508 may be uninstalled without uninstalling the original MIDlet 542.

For example, suppose that the MIDlet 542 is a game, and the extension 508 includes at least one additional level to the game. When the additional level is no longer needed, the user may uninstall it without uninstalling the game itself.

When the MIDlet extension 508 is uninstalled, the application manager 522 updates a system-level extensions property 540 that indicates how many extensions for the MIDlet 542 are installed on the MID 520. For example, suppose that before the extension 508 is uninstalled, the value of the extensions property 540 is “1,” meaning that one extension to the MIDlet 542 is installed on the MID 520. After the extension 508 is uninstalled, the application manager 522 may update the property 540 so that its value is “0,” meaning that no extensions to the MIDlet 542 are installed on the MID 520.

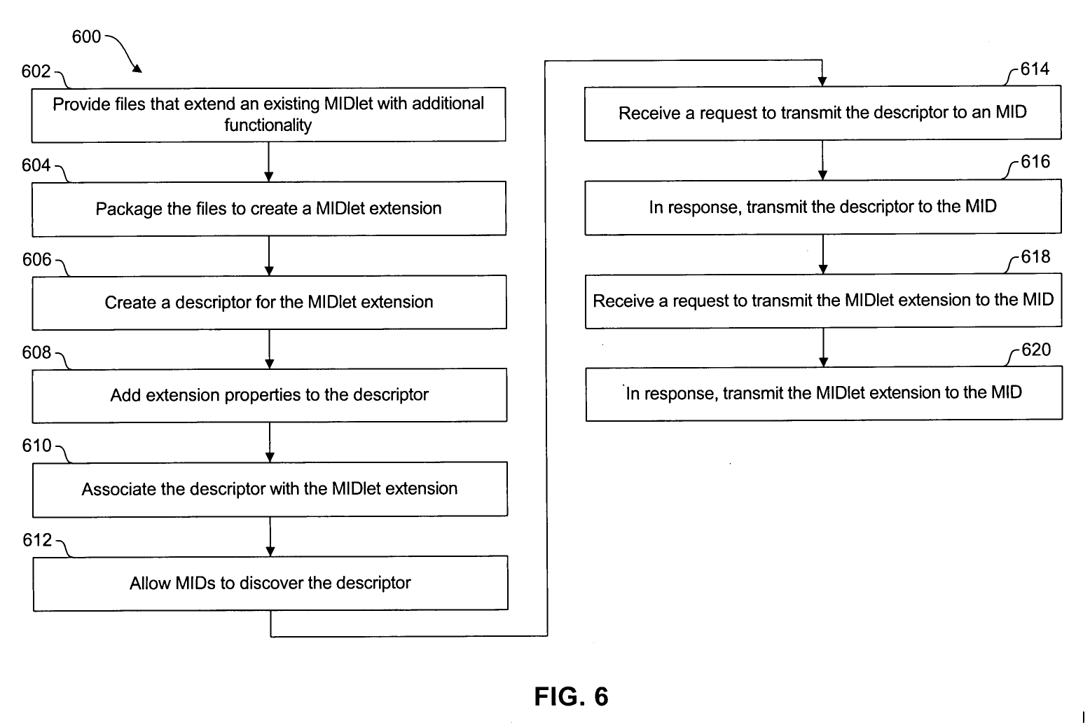

FIG. 6 illustrates an embodiment of a method 600 for extending a MIDlet with additional functionality. The method 600 may be performed by components in an MIDP server system 102.

The method 600 involves providing 602 files 104 that extend a MIDlet with additional functionality. The files 104 may include Java® class files, content files (e.g., images), etc. A packaging component 106 packages 604 the files to create a MIDlet extension 108. The packaging component 106 also creates 606 a descriptor 112 for the MIDlet extension 108. As indicated above, the descriptor 112 is a separate file that includes information about the MIDlet extension 108.

The packaging component 106 adds 608 one or more extension properties 114 to the descriptor 112. The extension properties 114 identify the MIDlet extension 108 as an extension to an existing MIDlet, and facilitate discovery of the MIDlet extension 108. Some examples of extension properties 114 include a name property 214a, a vendor property 214b, a version property 214c, etc. The descriptor 112 is associated 610 with the MIDlet extension 108.

MIDs 320 may be allowed 612 to discover the descriptor 112 for the MIDlet extension 108. At some point, a request handler 334 on the MIDP server system 102 receives 614 a request to transmit the descriptor 112 to an MID 320. In response, the request handler 334 fulfills the request and transmits 616 the descriptor 112 to the MID 320.

If the user decides to download the MIDlet extension 108, the request handler 334 receives 618 a request to transmit the MIDlet extension 108 to the MID 320. In response, the request handler 334 fulfills the request and transmits 620 the MIDlet extension 108 to the MID 320.

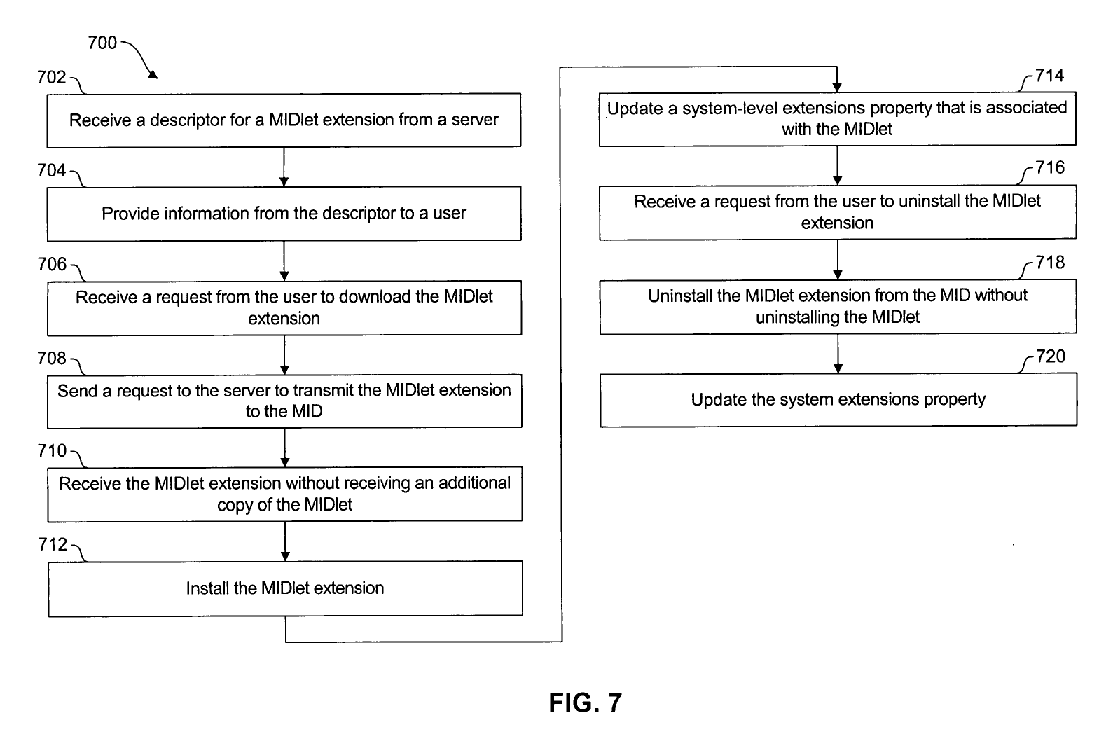

FIG. 7 illustrates another embodiment of a method 700 for extending a MIDlet with additional functionality. The method 700 may be performed by components in an MID 320.

An MID 320 receives 702 a descriptor 312 for a MIDlet extension 308 from an MIDP server system 302. An application manager 322 on the MID 320 provides 704 information from the descriptor 312 to the user of the MID 320. For example, the name of the MIDlet extension 308 may be displayed to the user, along with a brief description of the functionality that is provided by the MIDlet extension 308. This gives the user an opportunity to decide whether to download the MIDlet extension 308.

If the user decides to download the MIDlet extension 308, the application manager 322 receives 706 the user's request to download the MIDlet extension 308. In response to the user's request, the application manager 322 sends 708 a request to the MIDP server system 302 to transmit the MIDlet extension 308 to the MID 320. The MIDP server system 302 fulfills this request, and the application manager 322 receives 710 the MIDlet extension 308. When the MIDlet extension 308 is transmitted to the MID 320, the original MIDlet 342 does not have to be re-transmitted to the MID 320. Thus, the application manager 322 does not receive an additional copy of the original MIDlet 342.

An installer 336 installs 712 the MIDlet extension 308. The application manager 322 updates 714 a system-level extensions property 340 that is associated with the MIDlet 342. The system-level extensions property 340 indicates how many extensions for the MIDlet 342 have been installed on the MID 320.

At some point, the application manager 322 may receive 716 a request from the user to uninstall the MIDlet extension 308. In response to the request, the application manager 322 uninstalls 718 the MIDlet extension 308. Advantageously, the extension 308 may be uninstalled without uninstalling the original MIDlet 342. In response to the extension 308 being uninstalled, the application manager 322 updates 720 the system-level extensions property 340 associated with the MIDlet 342.

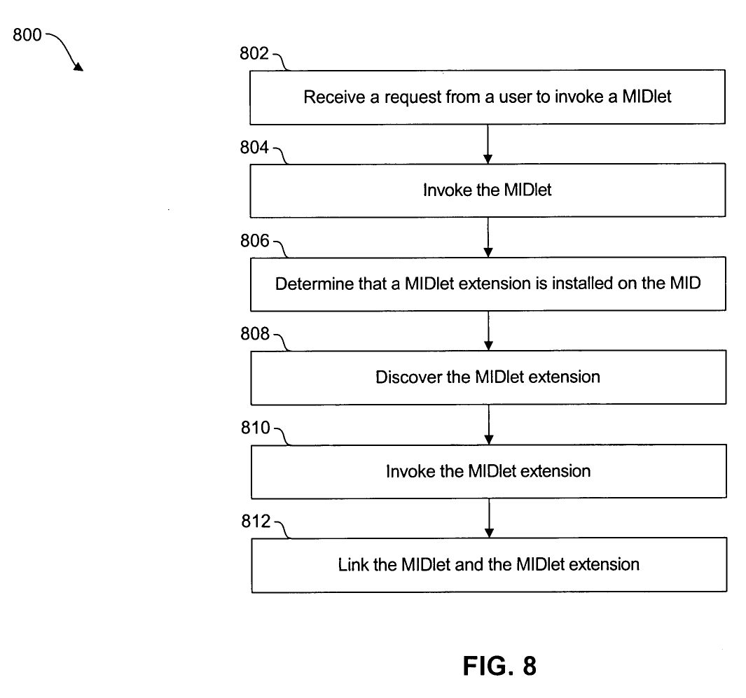

FIG. 8 illustrates another embodiment of a method 800 for extending a MIDlet with additional functionality. The method 800 may be performed by components in an MID 420.

An application manager 422 receives 802 a request from a user of the MID 420 to invoke a MIDlet 442. In response to the user's request, the application manager 422 invokes 804 the MIDlet 442. In some embodiments, this involves loading the MIDlet 442 into a JVM 444.

The application manager 422 determines 806 that a MIDlet extension 408 is installed on the MID 420. The application manager 422 may make this determination by querying a system-level extensions property 440 that indicates how many extensions for the MIDlet 442 have been installed on the MID 420.

The application manager 422 discovers 808 the MIDlet extension 408. The application manager 422 may discover the MIDlet extension 408 by querying the extension properties 414 within a descriptor 412 that is associated with the MIDlet extension 408.

The application manager 422 invokes 810 the MIDlet extension 408. In some embodiments, this involves loading the MIDlet extension 408 into the JVM 444. The MIDlet 442 and the MIDlet extension 408 are linked 812 so that the MIDlet 442 can access the MIDlet extension's 408 class and content files, and vice versa.

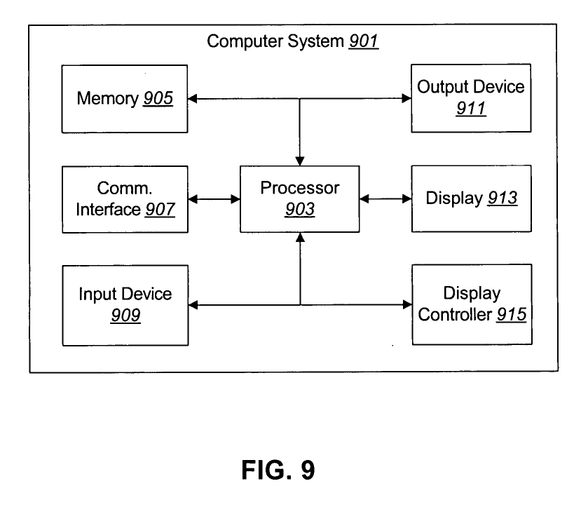

FIG. 9 illustrates the major hardware components typically utilized in a computer system 901, such as an MIDP server system 102 and/or an MID 320. The illustrated components may be located within the same physical structure or in separate housings or structures.

The computer system 901 includes a processor 903 and memory 905. The processor 903 controls the operation of the computer system 901 and may be embodied as a microprocessor, a microcontroller, a digital signal processor (DSP) or other device known in the art. The processor 903 typically performs logical and arithmetic operations based on program instructions stored within the memory 905.

As used herein, the term memory 905 is broadly defined as any electronic component capable of storing electronic information, and may be embodied as read only memory (ROM), random access memory (RAM), magnetic disk storage media, optical storage media, flash memory devices in RAM, on-board memory included with the processor 903, EPROM memory, EEPROM memory, registers, etc. The memory 905 typically stores program instructions and other types of data. The program instructions may be executed by the processor 903 to implement some or all of the methods disclosed herein.

The computer system 901 typically also includes one or more communication interfaces 907 for communicating with other electronic devices. The communication interfaces 907 may be based on wired communication technology, wireless communication technology, or both. Examples of different types of communication interfaces 907 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computer system 901 typically also includes one or more input devices 909 and one or more output devices 911. Examples of different kinds of input devices 909 include a keyboard, mouse, microphone, remote control device, button, joystick, trackball, touchpad, lightpen, etc. Examples of different kinds of output devices 911 include a speaker, printer, etc. One specific type of output device which is typically included in a computer system is a display device 913. Display devices 913 used with embodiments disclosed herein may utilize any suitable image projection technology, such as a cathode ray tube (CRT), liquid crystal display (LCD), light-emitting diode (LED), gas plasma, electroluminescence, or the like. A display controller 915 may also be provided, for converting data stored in the memory 905 into text, graphics, and/or moving images (as appropriate) shown on the display device 913.

Of course, FIG. 9 illustrates only one possible configuration of a computer system 901. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. In a server system that hosts one or more MIDlet suites and one or more MIDlet: descriptors for download, a method for extending a MIDlet with additional functionality, comprising:
providing one or more files that extend the MIDlet with additional functionality;
packaging the one or more files to create a MIDlet extension;
creating a descriptor for the MIDlet extension;
adding at least one extension property to the descriptor, wherein the at least one extension property identifies the MIDlet extension as an extension to the MIDlet and facilitates discovery of the MIDlet extension; and
associating the descriptor with the MIDlet extension.

2. The method of claim 1, wherein the at least one extension property comprises:
a name property that identifies a name of the MIDlet that is being extended;
a vendor property that identifies a vendor of the MIDlet that is being extended; and
a version property that identifies a version of the MIDlet that is being extended.

3. The method of claim 1, wherein the at least one extension property comprises an extension identifier.

4. The method of claim 1, further comprising allowing mobile information devices to discover the descriptor.

5. The method of claim 1, further comprising:
receiving a request from a mobile information device to transmit the descriptor to the mobile information device; and
transmitting the descriptor to the mobile information device in response to the request.

6. The method of claim 1, further comprising:
receiving a request from a mobile information device to transmit the MIDlet extension to the mobile information device; and
transmitting the MIDlet extension to the mobile information device in response to the request.

7. In a mobile information device, a method for extending a MIDlet with additional functionality, comprising:
receiving a descriptor for a MIDlet extension from a server, wherein the MIDlet extension comprises one or more files that extend the MIDlet with additional functionality;
providing information from the descriptor to a user;
receiving a download request from the user to download the MIDlet extension;
in response to the download request, sending a request to the server to transmit the MIDlet extension to the mobile information device;
receiving the MIDlet extension from the server without receiving an additional copy of the MIDlet; and
installing the MIDlet extension on the mobile information device.

8. The method of claim 7, further comprising updating a system-level extensions property that is associated with the MIDlet in response to installing the MIDlet extension.

9. The method of claim 7, further comprising:
receiving an uninstallation request from the user to uninstall the MIDlet extension; and
in response to the uninstallation request, uninstalling the MIDlet extension from the mobile information device without uninstalling the MIDlet.

10. The method of claim 9, further comprising updating a system-level extensions property that is associated with the MIDlet in response to uninstalling the MIDlet extension.

11. In a mobile information device, a method for extending a MIDlet with additional functionality, comprising:
receiving a request from a user to invoke a MIDlet;
invoking the MIDlet in response to the request;
determining that a MIDlet extension is installed on the mobile information device,
wherein the MIDlet extension extends the MIDlet with additional functionality;
discovering the MIDlet extension; and
invoking the MIDlet extension.

12. The method of claim 11, further comprising linking the MIDlet and the MIDlet extension.

13. The method of claim 11, wherein determining that the MIDlet extension is installed on the mobile information device comprises querying a system-level extensions property that is associated with the MIDlet.

14. The method of claim 11, wherein discovering the MIDlet extension comprises querying extensions properties within a descriptor that is associated with the MIDlet extension.

15. A mobile information device that is configured to implement a method for extending a MIDlet with additional functionality, the mobile information device comprising:
a processor;
memory in electronic communication with the processor;
instructions stored in the memory, the instructions being executable to implement a method comprising:
receiving a request from a user to invoke a MIDlet;
invoking the MIDlet in response to the request;
determining that a MIDlet extension is installed on the mobile information device,
wherein the MIDlet extension extends the MIDlet with additional functionality;
discovering the MIDlet extension; and
invoking the MIDlet extension.

16. A computer-readable medium comprising executable instructions for implementing a method for extending a MIDlet with additional functionality, the method comprising:
receiving a request from a user to invoke a MIDlet;
invoking the MIDlet in response to the request;
determining that a MIDlet extension is installed on the mobile information device,
wherein the MIDlet extension extends the MIDlet with additional functionality;
discovering the MIDlet extension; and
invoking the MIDlet extension.
